(19) United States
(12) Patent Application Publication
(10) Pub. No.: US 2009/0187577 A1
(43) Pub. Date: Jul. 23, 2009

(54) System and Method Providing Audio-on-Demand to a User's Personal Online Device as Part of an Online Audio Community

(76) Inventors: Aviv Reznik, Holon (IL); David Reznik, Holon (IL)

Correspondence Address: Naomi Assia Law Offices;C/O Landon IP Inc., Suite 450, 1700 Diagonal Road, Alexandria, VA, 22314, US

(21) Appl. No.: 12/017,034

(22) Filed: Jan. 20, 2008

(51) Int. Cl. G06F 17/30

(52) U.S. Cl. 707/10; 707/E17.032

(57) ABSTRACT

A system for a site in a communications network that holds a profile of favorite information sources for each of a plurality of registered users. The system includes a server to check the relevancy of items of audio content from radio and TV stations and items of audio-rendered RSS content from Web sites and pod-casts relative to the profiles. The server also transmits a list of the relevant content to each of the plurality of users accordingly. The system also includes a database for current and archival storage of the content and an RSS server to act as an RSS feed reader to format XML code into an easily readable format. Thus, each of the plurality of users is provided with a service enabling him to request items from the list and to listen to the requested relevant audio content at his convenience using a personal handheld device.

### FIELD OF THE INVENTION

The present invention relates generally to Web-based audio, and more particularly to systems and methods for providing audio content on-demand on a user's personal online device as part of an online audio community.

### BACKGROUND OF THE INVENTION

Information in all sizes and formats is flooding our world. The major information source is the Internet. Although some Websites provide special content, such as games, chats, communities, etc., a lot of sites provide “news,” both ordinary and extraordinary news. These sites are generally updated daily or weekly with new stories, and are therefore visited over and over for new reports.

| Earlier Media | New Media |
|---|---|
| Few sources playing to an | Millions of sources seeking the |
| audience of millions; | audience of a few; |
| Programs available on fixed schedule; | Programs available ‘On-Demand; |
| Content set by producer; | Content varied by audience; |
| Non-participative; and | Interactive; and |
| Regional access. | Global access. |

Despite having sacred status, time is wasted over and over again by the modern way of living. Transportation especially, but also other activities, are a complete waste of time. These activities are usually performed automatically and thoughtlessly, where the ears and mind are completely unused. The ears and mind are more often used for music listening or talking on the phone.

The Internet can be accessed from almost anywhere. Many mobile phones support surfing the Web. Mobile phones nowadays support constant connection to the Internet via high-speed connections. Wi-max is here and entire cities can be connected to the Internet. This trend is expected to increase rapidly over the next decade. According to ComScore the mobile Web audience in 2007 is one-fifth the size of the PC-based Internet audience in the U.K and mobile phone Web users nearly equal PC based Internet users in Japan. In the U.S. the Mobile Web market of 30 million is 19 percent of the 159 million U.S. PC Web users over 15, who accessed the Web from a mobile device during January, 2007.

Apple estimates that 30 million iPhones will be sold in 2011.

The following US patent applications constitute prior art of the present invention:

US Pat. Applic. No. 20050273706, Systems and methods for identifying and extracting data from HTML pages, by Manber, et al, discloses systems and methods for analyzing HTML formatted web pages to automatically identify and extract desired information. A computer algorithm identifies and extracts different pieces of information from different web pages automatically after minimal manual setup. The algorithm automatically analyzes pages with different content if they have the same, or similar, formats. The algorithm is fast and efficient and performs the extraction process quickly in real-time. The systems and methods are useful to build databases from unstructured web information. The algorithm can be used as an agent that captures information about products, and compares prices or other characteristics. It can also be used to populate structured databases that, given the different pieces of information, can analyze products and their characteristics. And it can also be used for data mining applications looking for patterns useful for marketing analyses, or other uses.

US Pat. Applic. No. 20070101313, Publishing synthesized RSS content as an audio file, by Bodin, et al, discloses methods, systems, and products for publishing synthesized RSS content as an audio file which include selecting synthesized RSS content; selecting a file type; converting the text and markup of the synthesized RSS content to waveform data of the selected file type, the waveform data containing speech presentation of the synthesized RSS content; and recording the waveform data of the selected file type. Publishing synthesized RSS content as an audio file may also include transferring the recorded waveform data of the selected file type to a recording medium for playback.

US Pat. Applic. No. 20070213857, RSS content administration for rendering RSS content on a digital audio player, by Bodin, et al, teaches methods, systems, and computer program products for RSS content administration for rendering RSS content on a digital audio player. Embodiments include retrieving, through an RSS feed, RSS content; extracting text from the RSS content; creating a media file; and storing the extracted text of the RSS content as metadata associated with the media file. Embodiments also typically include extracting one or more images from the RSS content; and storing the extracted images as metadata associated with the media file. Embodiments also typically include extracting text from the RSS content for audio rendering on the digital audio player; converting the text to speech; and recording the speech in the audio portion of the media file. Many embodiments also include storing the media file on a digital audio player; displaying the metadata describing the media file; and playing the audio portion containing the speech.

US Pat. Applic. No. 20070214485, Podcasting content associated with a user account, again by Bodin, et al, teaches methods, systems, and products for podcasting content associated with a user account. Embodiments include aggregating, for a user, content of disparate data types from disparate data sources; synthesizing the aggregated content of disparate data types into a podcast capable of being rendered on a digital media player; and providing the podcast for download from a URL. Embodiments also typically include receiving a request for the podcast; and transmitting in response to the request the podcast in a response to the request.

US Pat. Applic. No. 20070214149, Associating user selected content management directives with user selected ratings. Embodiments include synthesizing content of disparate data types into synthesized content in a media file for delivery to a particular digital audio player; transmitting the synthesized content to the digital audio player; rendering the content in the media file on the digital audio player; receiving, from a user in response to rendering the content, a rating for the content; associating the rating with the content in the media file; informing the consolidated content management server of the rating associated with the content in the media file; selecting in dependence upon the rating one or more content management directives; and executing the content management directives.

US Pat. Applic. No. 20070214148, by Bodin, et al, Invoking Content Management Directives. (same abstract)

US Pat. Applic. No. 20070214147, Informing a user of a content management directive associated with a rating. (same abstract)

There are many Web sites trying to provide high bandwidth video content for the tiny capacity screen of these phone devices. But there is little development effort being expended on the extremely low bandwidth audio band available with these essentially audio devices. Thus, it would be advantageous to provide more desirable audio content for online audio-enabled devices.

### SUMMARY OF THE INVENTION

Accordingly, it is a principal object of the present invention to provide audio more desirable content and advertising for online audio-enabled devices for online audio-enabled devices for the benefit of an online audio community.

It is another principal object of the present invention to provide new applications for targeted audio advertising for online audio-enabled devices for the benefit of an online audio community.

It is one other principal object of the present invention to provide text-to-speech for additional audio content availability for online audio-enabled devices for the benefit of an online audio community.

A system is disclosed for a Web site in a communications network that holds a profile of favorite information sources for each of a plurality of registered users. The system includes a server to check the relevancy of items of audio content from radio and TV stations and items of audio-rendered RSS content from Web sites and pod-casts relative to the profiles. The server also transmits a list of the relevant content to each of the plurality of users accordingly. The system also includes a database for current and archival storage of the content and an RSS server to act as an RSS feed reader to format XML code into an easily readable format. Thus, each of the plurality of users is provided with a service enabling him to request items from the list and to listen to the requested relevant audio content at his convenience using a personal handheld device.

The present invention enables users who are traveling with a personal digital assistant (PDA), mobile phone or laptop to receive the content of sites while on the road. A TTS (Text-To-Speech) agent can read these sites, allowing free hands and free eyes to focus on daily routines. The overall concept of the present invention is Listen On Demand (LOD) or VirtuaListen.

The VirtuaListen homepage will have 2 faces:

1. A PC/Laptop interface:
provides convenient registration to the service of the present invention and enables download of content as MP3; and
serving as a community portal enabling users with similar areas of interest to find each other and exchange ideas.

2. A PDA/Mobile interface providing the portal to one's account on the road.

RSS, or RSS feeds, is short for “Really Simple Syndication,” a.k.a. Rich Site Summary or RDF Site Summary, refers to a group of XML based Web-content distribution and republication (Web syndication) formats primarily used by news sites and Weblogs (blogs). Any Website can issue an RSS feed. By subscribing to an RSS feed, you are alerted to new additions to the feed since you last read it. In order to read RSS feeds, you must use a “feed reader,” which formats the XML code into an easily readable format. Feed readers are to XML and RSS feeds as web browsers are to HTML and Web pages.

Text-To-Speech considerations:

Has developed considerably in the past few years;

Many third-party packages enable personal customization; and

Can be easily integrated into the present invention system.

The present invention extracts text from a Web site according to “Profiling:”

Each site should have a Profile;

The profile dictates how the text is extracted from a report that appears on the site;

The present invention provides an inner tool for profiling;

The tool can be used by non-programmers;

The present invention also provides automatic extraction.

Automatic extraction allows site reports to be extracted without human input except for observation;

Automatic extraction allows easy tracking of format changes, i.e., easy observation;

Automatic extraction dramatically reduces maintenance costs; and

Automatic extraction allows quick addition of a site to the system

The innovative features of the present invention:
1. Web site reading initiated by user-account;
2. Profiling of sites; and a method of automatic extraction.
3. Formation of communities based on common interests.

The present invention provides Radio-On-Demand or even more precisely a Listen-On-Demand Service based on any personal devices such as Palms, iPhones, Mobile phones and Laptops.
1. A user can open an account in our Web site, and then
2. Log in from any device that has a constant connection to the Internet.
3. When registering to the service, the user lists his interests and
4. User's account is thereafter continuously filled with new stories and reports in his areas of interest.
5. The news reports are
   a. Web sites turned into TEXT-TO-SPEECH and maybe
      Other sources of information that update daily/weekly/monthly such as:
   b. radio stations,
   c. pod casts of certain sites,
   d. TV shows (only the audio), etc.
6. When logged into his account, from any appropriate device, the user can listen to the news reports via
   a. streaming, or
   b. download them as MP3's, if the device supports persistent memory.
7. The user can also find other users with common interests and share interests/sites and talk; therefore the present invention enables the formation of communities based on users' common fields of interest.
8. When streaming audio content that used to be textual, a special format is used instead of a regular audio file, which is easily converted to sound by the system.
9. Text is not only easily converted to sound, but also, in the process, the bandwidth is minimized. The bandwidth is much less than that required for MP3, for example.

The US patent applications, constituting prior art listed in the background are contrasted with the present invention as follows:

US Pat. Applic. No. 20050273706, Systems and methods for identifying and extracting data from HTML pages, by Manber, et al. The present invention, by contrast, has a different approach to HTML parsing. The system of the present invention is completely manual. That is, one manually builds rules for a certain site. Alternatively, the present invention parses HTML semi-automatically in the following way:

An area of interest is selected in a particular page of a particular Website. ANOTHER area of interest is selected on another page of the same site. A comparing algorithm then determines rules that will extract the area of interest of BOTH pages. I.e., the area of interest the first page is extracted, and then the area of interest the second page is extracted. In a preferred embodiment 2 new forms of completely automatic tools are provided—
1) The page is examined combining image processing with HTML information. The HTML content is rendered on a virtual buffer, where each graphical region retains its connection with the related HTML element. The important “parent” story element is extracted according to its location (in the middle of the screen). For each “child” element (starting from the story element) the ratio of textual area and image/link/other area is calculated. If less than 1, the entire element is removed. The remaining elements are the story elements.
2) The “density” of text in an HTML document is calculated in the following way. The number of bytes in the HTML file is divided by the number of bytes of text eventually displayed when rendered. When the density is lower than 0.5 it is assumed this is a story text element.

US Pat. Applic. No. 20070101313, Publishing synthesized RSS content as an audio file, by Bodin, et al. “RSS Content” refers to “the content of the RSS xml file.” RSS is simply an address that returns an XML file describing the latest links in a certain site. By contrast, the present invention simply goes to the published link, and extracts information from the link itself. The RSS content itself is not converted into audio. It is assumed “publishing” means streaming from a Web site over an HTTP protocol. When text-to-speech is applied by the present invention, i.e., when the user gets an item that was initially text, the system does not receive a wavefile, but receives data in a special format that can be easily converted to sound on the system.

US Pat. Applic. No. 20070213857, RSS content administration for rendering RSS content on a digital audio player, by Bodin, et al. Here Bodin provides rendering of the content directly on the digital audio player. By contrast, the present invention provides a Web-site, and streams the audio to any online device, such as one that might wish to save it as an MP3 file.

US Pat. Applic. No. 20070214485, Podcasting content associated with a user account, again by Bodin, et al. Here Bodin provides podcasting as the method of publication. By contrast, the present invention provides a simple Web-site interface. Also, Bodin only refers to data that came from disparate types and disparate sources. By contrast, the present invention provides audio content from many sources, where one option is to simply send Web-site converted text using Text-To-Speech and nothing else. Another issue is the fact that Bodin aggregates everything on a single media file. The present invention does not do that, rather each Web page is saved/published a via a different file/stream.

These next 3 patents regard rating association with user content and they have identical abstracts. These patents are too general. Many sites today have ratings for user associated content.

US Pat. Applic. No. 20070214149, by Bodin, et al, Associating User Selected Content Management Directives with User Selected Ratings.

US Pat. Applic. No. 20070214148, by Bodin, et al, Invoking Content Management Directives.

US Pat. Applic. No. 20070214147, by Bodin, et al, Informing a User of a Content Management Directive Associated with a Rating.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic illustration of a system block diagram, constructed in accordance with the principles of the present invention;

FIG. 2 is a flow chart of the method for real time listening on demand utilizing social networks, performed according to the principles of the present invention; and

FIG. 3 is a flow chart continuation of the flow chart of FIG. 2, performed according to the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

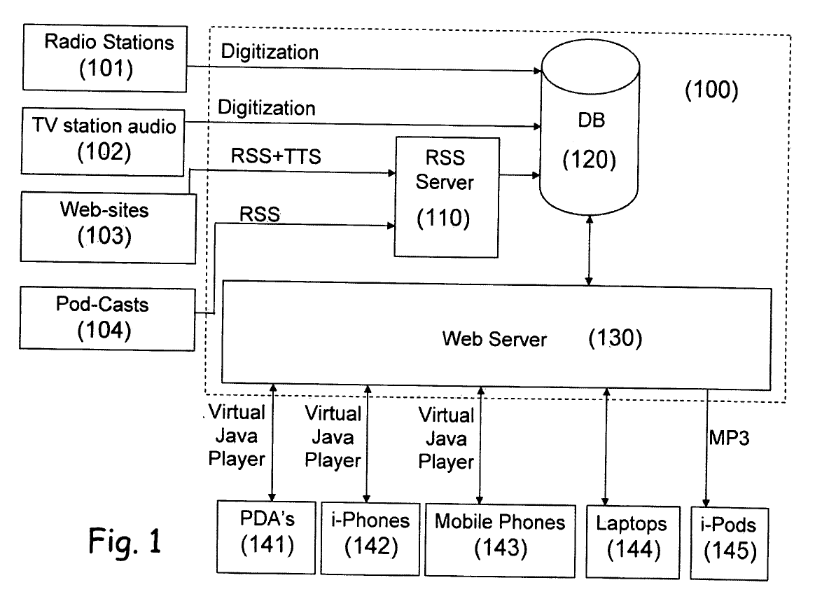

FIG. 1 is a schematic illustration of a system block diagram, constructed in accordance with the principles of the present invention. A Web server 130, preferably residing at an entrepreneurial Web site 100, contains a database 120 of digitized audio input from radio stations 101 and TV stations 102, RSS and TTS input from Websites 103 and RSS input from pod-casts 104. Users connect to Web server 130 via virtual Java players with their PDA's 141, i-phones 142 and mobile phones 143. Users also connect to Web server 130 with their laptops 144 and via MP3 with their i-pods 145.

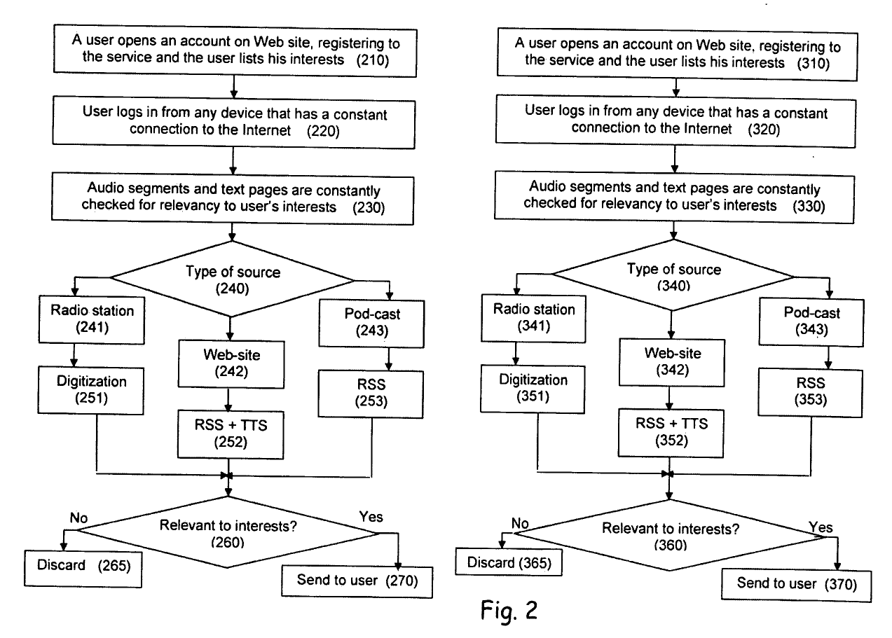

FIG. 2 is a flow chart of the method for real time listening on demand utilizing social networks, performed according to the principles of the present invention. A first user opens an account on the proprietary Web site, registering to the service and the user lists his interests 210. The user logs in from any device that has a constant connection to the Internet 220. Audio segments and text pages are constantly checked for relevancy to user's interests 230. According to the type of source 240, such as a radio station 241, Web site 242 or pod-cast 243, the content is digitized 251, processed by RSS+TTS 252 or processed by RSS alone 253, accordingly. If the content is relevant to the user 260, it is sent to the user 270. Otherwise it is discarded 265.

Similarly, a second user opens an account on the proprietary Web site, registering to the service and the user lists his interests 310. The user logs in from any device that has a constant connection to the Internet 320. Audio segments and text pages are constantly checked for relevancy to user's interests 330. According to the type of source 340, such as a radio station 341, Web site 342 or pod-cast 343, the content is digitized 351, processed by RSS+TTS 352 or processed by RSS alone 353, accordingly. If the content is relevant to the user 360, it is sent to the user 370. Otherwise it is discarded 365.

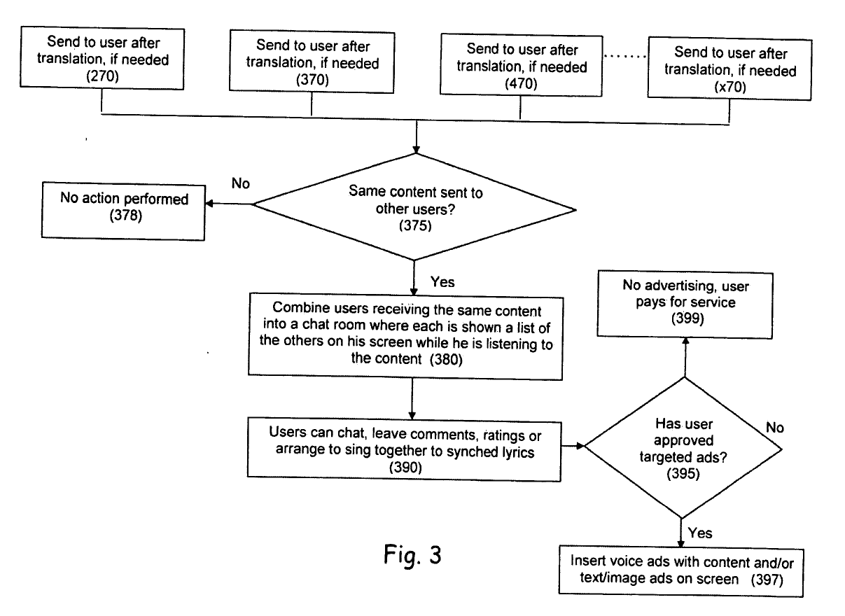

FIG. 3 is a flow chart continuation of the flow chart of FIG. 2, performed according to the principles of the present invention. If the content is relevant to the first and second users 260 and 360, it is sent to the users 270 and 370. This may be repeated for a third user 470 and for any number × users ×70. For each user to whom the content is relevant and to whom it is sent, a translation may be done before sending, if the user has specified a language different from the language of the content. For the academic community this would enable scholarly collaboration on common research topics with instant updates and provide an improved forum for talk radio for politics and sports, for example.

A broadway play opened in December 2007 called “The Farnsworth Invention.” It tells the true story of Philo Farnsworth, a genius from Rigby, Id. who at the unbelievable age of 14, invented television only to become involved in an all or nothing battle with David Sarnoff, the young president of RCA and America's first communications mogul.” It's a classic American tale driven by the conflict between a Mormon farmer and a Russian immigrant over the ownership of the most influential invention of the 20th Century. In anticipation of the opening of the play an intense international chatroom debate in English text broke out as to who actually invented TV. Was it Farnsworth, Zworkin (a Russian inventor working for Sarnoff), Baird, a Scottish inventor, or any one of several other inventors from various countries. One had to keep checking constantly for new posts and to scroll through the old posts to get to the new posts.

With the present invention there is an auto update and the user accesses at his leisure or chosen time of “ears free, body otherwise occupied.” Global participants receive the latest posts in their own language 375. When a professor in India writes a paper, the paper is translated into English and every other language of those with that topic in their interest profile. Highly targeted advertising is made possible by the interest profiles. Also, users can have a conference audio chat with the item played in the background 380. The simultaneous access for music enables users to sing along together to synched music 390. Grouped users can also chat, or leave recorded or text comments. If there is only one recipient, no further action is performed after sending the audio content to him 376.

If the user has approved advertising 395, targeted voice and screen messages are included with the content sent to the user 397. If he has not approved, the user pays for the service 396.

In another example of using the present invention four users can start an audio chat while their favorite food show is broadcast in the background, synchronized between the four of them. They can talk about show while it is playing, thereby enhancing the experience.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A system for a site in a communications network that holds a profile of favorite information sources for each of a plurality of registered users, said system comprising:
a server to check the relevancy of items of audio content from radio and TV stations and items of audio-rendered RSS content from Web sites and pod-casts relative to the profiles and to transmit a list of said relevant content to each of the plurality of users accordingly;
a database for current and archival storage of said content; and
an RSS server to act as an RSS feed reader to format XML code into an easily readable format,
such that each of the plurality of users is provided with a service enabling him to request items from said list and to listen to said requested relevant audio content at his convenience using a personal handheld device.

2. The system of claim 1, wherein the site is a Web site, the communications network is the Internet and the server is a Web server.

3. The system of claim 2, wherein the profile reflects the plurality of users' favorite information sources comprising at least: Web pages, radio stations, TV shows and pod-casts.

4. The system of claim 2, wherein the Web site provides a way for the plurality of users having related profiles to communicate with each other, search one another and exchange information comprising at least text messages and favorite information sources.

5. The system of claim 2, wherein the Web site provides at least one of audio and textual information for each of the plurality of users from their favorite information sources as selected in the user profile.

6. The system of claim 2, wherein the Web site provides targeted advertising according to the profile of each of the plurality of user in at least one of an audio and textual format.

7. The system of claim 1, wherein the service provides segments of audio on demand, and wherein each of said requested items is received from at least one of the following sources: radio stations, Web sites, third party content providers, pod-casts, TV non-news programs and TV news reports.

8. The system of claim 1, wherein the audio/video content can be played on any said personal handheld device comprising at least one of: iPhone, Mobile phone, Palm computer, laptop computer and PDA.

9. The system of claim 1, wherein the service enables remote learning and participation in community activities.

10. The system of claim 1, wherein the service enables each of the plurality of users to enjoy the service while driving.

11. The system of claim 1, wherein said audio content from radio enables Radio-On-Demand, wherein each of the plurality of users can listen to any Radio program on demand from the archives using his said personal handheld device.

12. The system of claim 1, wherein the service provides an audio chat room for groups comprised from the plurality of users having common interests, and wherein the common audio/video content is played on their personal handheld devices in the background while they chat.

13. The system of claim 12, wherein the audio chat room provides an option for use of one of real names and nicknames.

14. The system of claim 12, wherein the audio chat room provides an option for use of an avatar option by each of the plurality of users.
